(19) United States
(12) Patent Application Publication
(10) Pub. No.: US 2016/0219053 A1
(43) Pub. Date: Jul. 28, 2016

(54) INTELLIGENT TERMINAL AND INTERACTIVE CONTROL SYSTEM AND INTERACTIVE CONTROL METHOD USING SAME

(71) Applicant: DANZHI CAI, Shenzhen (CN)

(72) Inventor: DANZHI CAI, Shenzhen (CN)

(21) Appl. No.: 14/606,437

(22) Filed: Jan. 27, 2015

(51) Int. Cl. H04L 29/06; H04L 29/08

(52) U.S. Cl. CPC H04L 63/10; H04L 67/1097

(57) ABSTRACT

An interactive control method is provided. The method is applied to an intelligent terminal. The intelligent terminal includes a storage unit. The method includes the following. The intelligent terminal receives an inquiry signal transmitted from a remote server. The intelligent terminal inquires a user whether to store conversations in response to the inquiry signal. The intelligent terminal generates a first storage request when storing the conversations is selected and further transmits the first storage request to the remote server. A second storage request generated by another intelligent terminal is further transmitted to the remote server and a storage authorization is generated according to the first storage request and the second storage request by the remote server and transmitted to the intelligent terminal. The intelligent terminal controls the storage unit to store the conversations according to the storage authorization.

### FIELD

The subject matter herein generally relates to intelligent terminals, interactive control systems and interactive methods for protecting privacy.

### BACKGROUND

With the development of science and technology, communication via Internet is becoming more and more popular. Accordingly, security measures that have been in place in more traditional forms of communication, such as letters, should now be applied to the increasingly broad spectrum of electronic communications. This may be necessary to control propagation and prevent unintended dissemination of sensitive information.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of an interactive control system.

FIG. 2 is a block diagram of an embodiment of an operating environment of an interactive control system shown in FIG. 1.

FIG. 3 is a block diagram of another embodiment of an operating environment of an interactive control system.

FIG. 4 is a flowchart of an embodiment of an interactive control method shown in FIG. 3.

FIG. 5 is an isometric view of an embodiment of a female sexual stimulation device.

FIG. 6 is an isometric view of an embodiment of a male sexual stimulation device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

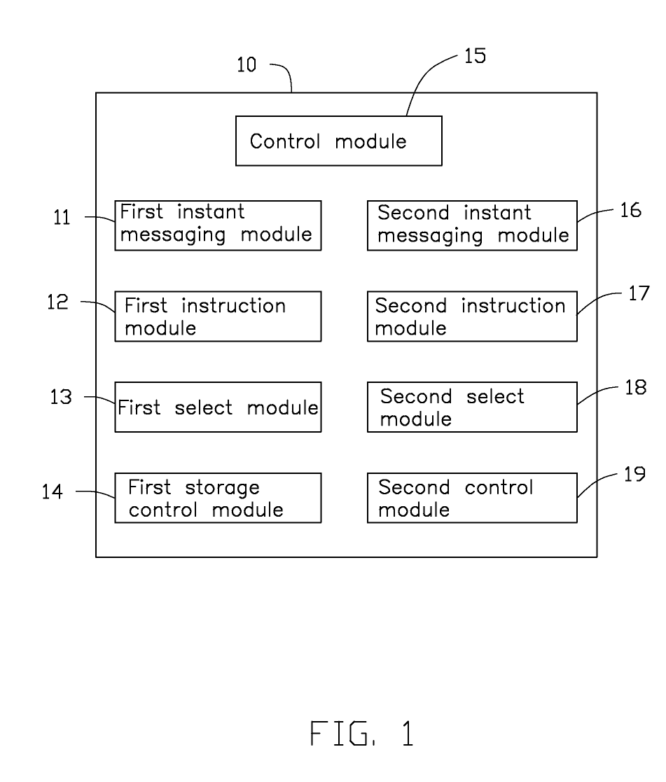

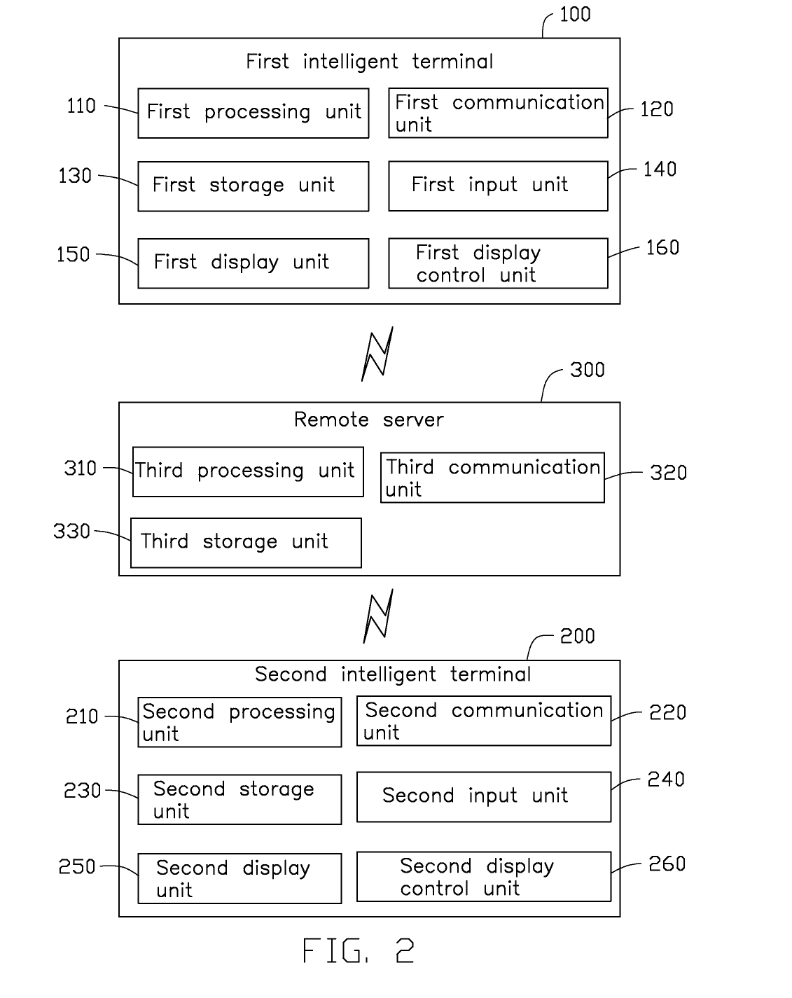

The interactive control system 10 can be run in but not limited to at least one intelligent terminal and a remoter server. Referring to FIG. 1 and FIG. 2, an interactive control system 10 is illustrated. In this embodiment, for description convenience, the interactive control system 10 can be run in a first intelligent terminal 100, a second intelligent terminal 200 and a remoter server 300 as shown in FIG. 2, which is just an example, but not a limitation to the invention

The first intelligent terminal 100 can be a mobile phone, or a computer includes, but not limited to, a portable computer, or a tablet computer, or a desktop computer. The first intelligent terminal 100 can include a first processing unit 110, a first communication unit 120, a first storage unit 130, a first input unit 140, a first display unit 150 and a first display control unit 160.

The second intelligent terminal 200 can be a mobile phone, or a computer includes, but not limited to, a portable computer, or a tablet computer, or a desktop computer. The second intelligent terminal 200 can include a second processing unit 210, a second communication unit 220, a second storage unit 230, a second input unit 240, a second display unit 250 and a second display control unit 260. The remote server 300 can include a third processing unit 310, a third communication unit 320 and a third storage unit 330.

The first communication unit 120 can be used to connect the first intelligent terminal 100 to the third communication unit 320 of the remote server 300.

The second communication unit 220 can be used to connect the second intelligent terminal 200 to the third communication unit 320 of the remote server 300.

The interactive control system 10 can include a first instant messaging module 11, a first instruction module 12, a first select module 13, a first manage module 14, a control module 15, a second instant messaging module 16, a second instruction module 17, a second select module 18 and a second control module 19. In the embodiment, the first instant messaging module 11, the first instruction module 12, the first select module 13 and the first manage module 14 can be a collection of software instructions stored in the first storage unit 130 of the first intelligent terminal 100 and executed by the first processing unit 110 of the first intelligent terminal 100. The control module 15 can be a collection of software instructions stored in the third storage unit 330 of the remote server 300 and executed by the third processing unit 310 of the remote server 300. The second instant messaging module 16, the second instruction module 17, the second select module 18 and the second control module 19 can be a collection of soft instructions stored in the second storage unit 230 of the second intelligent terminal 200 and executed by the second processing unit 210 of the second intelligent terminal 200. The modules of the control system 10 also can include functionality represented as hardware or integrated circuits, or as software and hardware combinations, such as a special-purpose processor or a general-purpose processor with special-purpose firmware.

In at least one embodiment, the all of modules of the control system 10 can be stored in the first storage unit 130 of the first intelligent terminal 100 and executed by the first processing unit 110 of the first intelligent terminal 100, or can be stored in the second storage unit 230 of the second intelligent terminal 200 and executed by the second processing unit 210 of the remote server 300, or can be stored in the third storage unit 330 of the remote server 300 and executed by the third processing unit 310 of the third intelligent terminal 200.

In at least one embodiment, the first processing unit 110, the second processing unit 210 and the third processing unit 310 can be a central processing unit, a digital signal processor, or a single chip, for example. In at least one embodiment, the first storage unit 130, the second storage unit 230 and the third storage unit 330 can be an internal storage system, such as a flash memory, a random access memory (RAM) for temporary storage of information, and/or a read-only memory (ROM) for permanent storage of information.

The first storage unit 130, the second storage unit 230 and the third storage unit 330 can also be a storage system, such as a hard disk, a storage card, or a data storage medium. The first storage unit 130, the second storage unit 230 and the third storage unit 330 can include volatile and/or non-volatile storage devices. In at least one embodiment, the first storage unit 130, the second storage unit 230 and the third storage unit 330 can include two or more storage devices such that one storage device is a memory and the other storage device is a hard drive. Additionally, the first storage unit 130, the second storage unit 230 and the third storage unit 330 can be respectively located either entirely or partially external relative to the first intelligent terminal 100, the second intelligent terminal 200 and the remote server 300.

The first instant messaging module 11 can be used to generate a first instant message in response to a first user's input operation applied on the first input unit 140 and further control the first communication unit 120 to transmit the first instant message to the second intelligent terminal 200 via the remote server 300.

When the second intelligent terminal 200 receives the first instant message, the second display control unit 260 can be used to control the second display unit 250 to display the first instant message for a second user reading.

The second instant messaging module 16 can be used to generate a second instant message in response to a second user's input operation applied on the second input unit 240 and further control the second communication unit 220 to transmit the second instant message to the first intelligent terminal 100 via the remote server 300

When the first intelligent terminal 100 receives the second instant message, the first display control unit 160 can control the first display unit 150 to display the second instant message for a first user reading, thus, the first user and the second user can communicate with each other. For convenience of description, a general term of the number of first instant messages and the number of second instant messages can be called conversations.

When the first intelligent terminal 100 and the second intelligent terminal 200 finish communicating, the server 300 will send instructions to both the two intelligent terminals 100 and 200 to ask the two intelligent terminals 100 and 200 whether to store the conversations, and only if the two intelligent terminals 100 and 200 both select to store the conversations, the server 300 sends a storage instruction and an encryption key to the two intelligent terminals 100 and 200 to authorize the two intelligent terminals 100 and 200 to store the conversations and further encrypt the conversations, otherwise, the server 300 sends delete instructions to the two intelligent terminals 100 and 200 to authorize the two intelligent terminals 100 and 200 to delete the conversations. The details are shown as follows.

The first instruction module 12 can be used to generate a first instruction in response to a first user's operation applied on the first input unit 140 and further control the first communication unit 120 to transmit the first instruction to the remote server 300. The first user's operation can be selected from a group consisting of: close a chat window, click a “store” button, or click a “delete” button or other suitable operations.

The second instruction module 17 can be used to generate a second instruction in response to a second user's operation applied on the second input unit 240 and further control the second communication unit 220 to transmit the second instruction to the remote server 300. The second user's operation can be selected from a group consisting of: close a chat window, click a “store” button, or click a “delete” button or other suitable operations.

The control module 15 can be used to generate an inquiry signal and further control the third communication unit 320 to transmit the inquiry signal to the first intelligent terminal 100 and the second intelligent terminal 200.

The first select module 13 can be used to generate a first dialog box containing a “yes” option and a “no” option to inquire the first user whether to store the conversations in response to the inquiry signal, and further select the “yes” option in response to a user's select operation applied on the “yes” option or select the “no” option in response to a user's select operation applied on the “no” option, and generate a first storage request when the “yes” option is selected and generate a first delete request when the “no” operation is selected, and further control the first communication unit 120 to transmit the first storage request or the first delete request to the remote server 300.

The second select module 18 can be used to generate a second dialog box containing a “yes” option and a “no” option to inquire the second user whether to store the conversations in response to the inquiry signal, and select the “yes” option in response to the second user's select operation applied on the “yes” option or select the “no” option in response to the second user's select operation applied on the “no” option, and generate a second storage request when the “yes” option is selected and further generate a second delete request when the “no” option is selected, and further control the second communication unit 220 to transmit the second storage request or the second delete request to the remote server 300.

The control module 15 can be used to generate a storage authorization in response to both the first storage request and the second storage request, and further control the third communication unit 320 to transmit the storage authorization to both the first intelligent terminal 100 and the second intelligent terminal 200.

In at least one embodiment, the control module 15 can be used to further generate an encryption key in response to both the first storage request and the second storage request, and further control the third communication unit 320 to transmit the encryption key to both the first intelligent terminal 100 and the second intelligent terminal 200.

The control module 15 can be further used to generate a delete authorization in response to both the first storage request and the second delete request, and further control the third communication unit 320 to transmit the delete authorization to both the first intelligent terminal 100 and the second intelligent terminal 200.

The control module 15 can be further used to generate a delete authorization in response to both the first delete request and the second storage request, and further control the third communication unit 320 to transmit the delete authorization to both the first intelligent terminal 100 and the second intelligent terminal 200.

The control module 15 can be used to generate a delete authorization in response to both the first delete request and the second delete request, and further control the third communication unit 320 to transmit the delete authorization to both the first intelligent terminal 100 and the second intelligent terminal 200.

The first manage module 14 can be used to encrypt the conversations stored in the first storage unit 130 according to the encryption key, and further control the first storage unit 130 to store the encrypted conversations according to the storage authorization, and further delete the encryption key, or control the first storage unit 130 to delete the conversations according to the delete authorization. After the first storage unit 130 has stored the conversations, each time before opening the encrypted conversations, the first manage module 14 can be used to control the first intelligent terminal 100 to obtain the encryption key from the remote server 300 again and further decrypt the encrypted conversations according to the encryption key, and further delete the encryption key, which can protect privacy better.

In at least one embodiment, after the first storage unit 130 has stored the conversations, the first instruction module 12 can be used to generate a first delete instruction in response to a first user's delete operation applied on the first input unit 140 and further control the first communication unit 120 to transmit the first delete instruction to the remote server 300. The control module 15 can be further used to control the third storage unit 330 to delete the encryption key in response to the first delete instruction, after this, the encrypted conversations cannot be opened permanently.

The second manage module 19 can be used to encrypt the conversations stored in the second storage unit 230 according to the encryption key, and control the second storage unit 230 to store the encrypted conversations according to the storage authorization, and further delete the encryption key, or control the second storage unit 230 to delete the conversations according to delete authorization. After the second storage unit 230 has stored the encrypted conversations, each time before opening the encrypted conversations, the second manage module 19 can be used to control the second intelligent terminal 200 to obtain the encryption key from the remote server 300 and further decrypt the encrypted conversations according to the encryption key, and further delete the encryption key, which can protect privacy better.

In at least one embodiment, after the second storage unit 230 has stored the encrypted conversations, the second instruction module 17 can be further used to generate a second delete instruction in response to a second user's delete operation applied on the second input unit 240 and further control the second communication unit 220 to transmit the second delete instruction to the remote server 300. The control module 15 can be further used to control the third storage unit 330 to delete the encryption key in response to the second delete instruction, after this, the encrypted conversations cannot be opened permanently.

In this embodiment, the first storage unit 130 can include a first temporary storage unit (not shown) and a first permanent storage unit (not shown), and the second storage unit 230 can include a second temporary storage unit (not shown) and a second permanent storage unit (not shown). When the first intelligent terminal 100 and the second intelligent terminal 200 are communicating with each other, the conversations can be stored in the first temporary storage unit and the second temporary storage unit, and when the conversations are encrypted, the conversations can be stored in the first permanent storage unit and the second permanent storage unit.

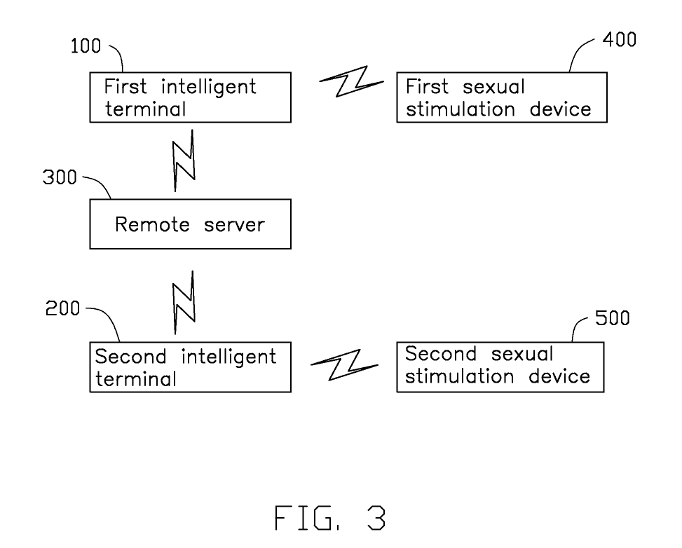

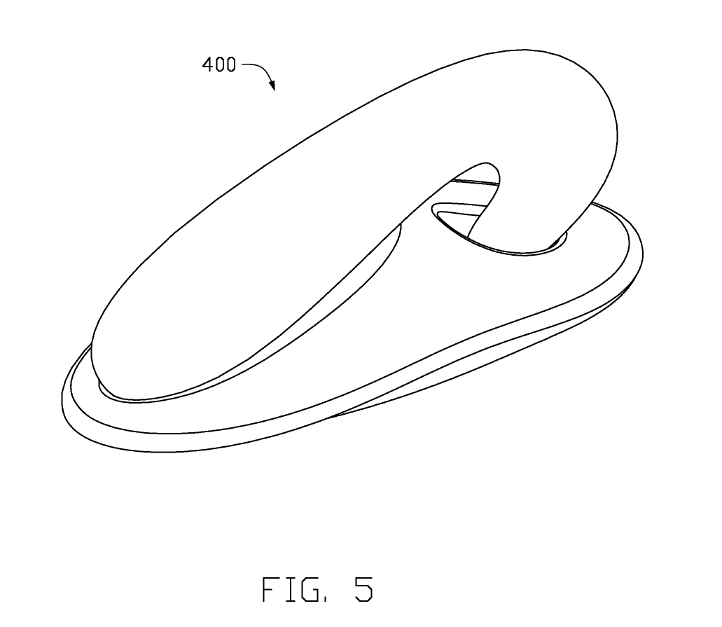

FIG. 3 shows a block diagram of an embodiment of an interactive control system. The first intelligent terminal 100 can be connected to a first sexual stimulation device 400. In at least one embodiment, the first sexual stimulation device 400 can be female sexual stimulation device, such as shown in FIG. 5, for female to use. The first instant message can include control information. The first intelligent terminal 100 can transmit the control information to the first sexual stimulation device 400, thus to control the first sexual stimulation device 400 to vibrate.

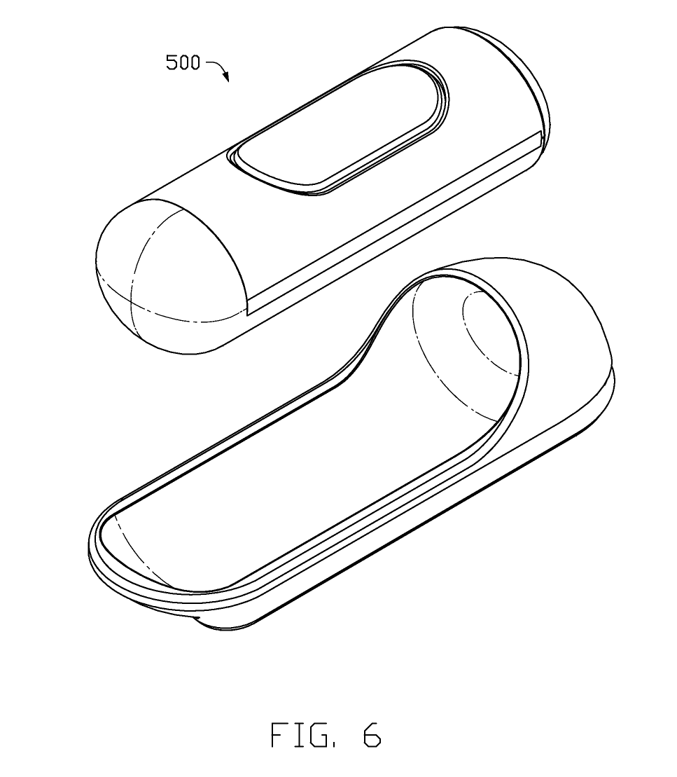

The second intelligent terminal 200 can be connected to a sexual stimulation device 500. The second sexual stimulation device 500 can be a male sexual stimulation device, such as shown in FIG. 6. The second instant message can include control information. The second intelligent terminal 200 can transmit the control information to the second sexual stimulation device 500, thus to control the second sexual stimulation device 500 to vibrate.

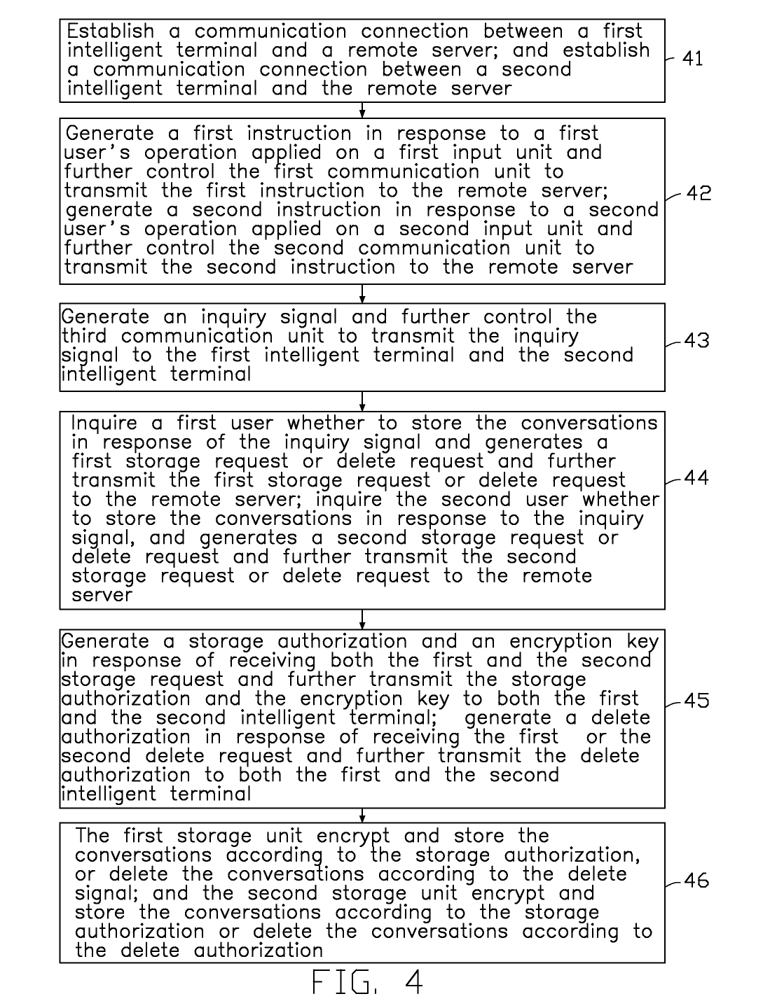

FIG. 4 illustrates a flowchart of the interactive control method. The method is provided by way of example, as there are a variety of ways to carry out the method. The method described below can be carried out using the configurations illustrated in FIG. 1, for example, and various elements of these figures are referenced in explaining the example method. Each block shown in FIG. 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 41.

At block 41, a first communication unit and a third communication unit establish a communication connection between the first intelligent terminal and the remote server; a second communication unit and the third communication unit establish a communication connection between the second intelligent terminal and the remote server.

At block 42, a first instruction module generates a first instruction in response to a first user's operation applied on a first input unit and further control the first communication unit to transmit the first instruction to the remote server; or a second instruction module generates a second instruction in response to a second user's operation applied on a second input unit and further control the second communication unit to transmit the second instruction to the remote server.

At block 43, a control module generates an inquiry signal in response to the first instruction or the second instruction and further control the third communication unit to transmit the inquiry signal to both the first intelligent terminal and the second intelligent terminal.

At block 44, a first select module inquires the first user whether to store the conversations in response to the inquiry signal, and generates a first storage request when storing the conversations is selected by the first user via the first intelligent terminal, or generates a first delete request when deleting the conversations is selected by the first user via the first intelligent terminal, and further control the first communication unit to transmit the first storage request or the first delete request to the remote server; a second select module inquires the second user whether to store the conversations in response to the inquiry signal, and generates a second storage request when storing the conversations is selected by the second user via the second intelligent terminal, or generates a second delete request when deleting the conversations is selected by the second user via the second intelligent terminal, and further control the second communication unit to transmit the second storage request or the second delete request to the remote server.

At block 45, the control module generates a storage authorization and an encryption key in response to both the first storage request and the second storage request and further control the third communication unit to transmit the storage authorization and the encryption key to both the first intelligent terminal and the second intelligent terminal; or further generate a delete authorization in response to the first delete request or the second delete request and further control the third communication unit to transmit the delete authorization to both the first intelligent terminal and the second intelligent terminal.

At block 46, a first manage module encrypts the conversations stored in a first storage unit according to the encryption key and controls a first storage unit to store the encrypted conversations according to the storage authorization and further deletes the encryption key, or control the first storage unit to delete the conversations according to the delete authorization; and a second manage module encrypts the conversations stored in a second storage unit according to the encryption key, and controls a second storage unit to store the conversations according to the storage authorization, and further deletes the encryption key, or control the second storage unit to delete the conversations according to the delete authorization.

The conversations can be stored in the two intelligent terminals, but not the remote server, which alleviates the burden of the remote server, and further makes the user feel more safety.

The stored conversations can be opened with an encryption key, but the encryption key is stored in the remote server, which increases the difficulty of opening the stored conversations.

The two intelligent terminals have the rights to store the conversations, and the remote server has the rights to manage the conversations, which achieves the separation of the rights and improves the safety level of the conversations.

After the conversations have been stored, if any one intelligent terminal transmits a delete instruction to the remote server, the remote server would delete the wants to delete the encryption key, thus, the conversations stored in any one intelligent terminal would not be opened permanently, which increase the convenience for deleting the stored conversations.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An interactive control system, applied to a first intelligent terminal, a second intelligent terminal and a remote server, the first intelligent terminal comprising a first storage unit, the second intelligent terminal comprising a second storage unit, the interactive control system comprising a plurality of processing units and a plurality of modules which are collections of instructions executed by the plurality of processing units, the plurality of modules comprising:
a control module configured to generate an inquiry signal and further transmit the inquiry signal to both the first intelligent terminal and the second intelligent terminal;
a first select module configured to inquire a first user whether to store conversations in response to the inquiry signal, and generate a first storage request when storing the conversations is selected and further transmit the first storage request to the remote server;
a second select module configured to inquire a second user whether to store the conversations in response to the inquiry signal, and generate a second storage request when storing the conversations is selected and further transmit the second storage request to the remote server;
the control module further configured to generate a storage authorization in response to both the first storage request and the second storage request; and further transmit the storage authorization to both the first intelligent terminal and the second intelligent terminal;
a first manage module configured to control the first storage unit to store the conversations according to the storage authorization; and
a second manage module configured to control the second storage unit to store the conversations according to the storage authorization.

2. The interactive control system of claim 1, wherein the first select module is configured to generate a first delete request when deleting the conversations is selected and further transmit the first delete request to the remote server; and the control module is further configured to generate a delete authorization in response to the first delete request and the second storage request, and further transmit the delete authorization to both the first intelligent terminal and the second intelligent terminal; and the first manage module is further configured to control the first storage unit to delete the conversations according to the delete authorization; and the second manage module is further configured to control the second storage unit to delete the conversations according to the delete authorization.

3. The interactive control system of claim 1, wherein the second select module is configured to generate a second delete request when deleting the conversations is selected and further transmit the second storage request to the remote server; and the control module is further configured to generate a delete authorization in response to the first storage request and the second delete request, and further transmit the delete authorization to both the first intelligent terminal and the second intelligent terminal; and the first manage module is further configured to control the first storage unit to delete the conversations according to the delete authorization; and the second manage module is further configured to control the second storage unit to delete the conversations according to the delete authorization.

4. The interactive control system of claim 1, wherein the first select module is configured to generate a first delete request when deleting the conversations is selected and further transmit the first delete request to the remote server; the second select module is configured to generate a second delete request when deleting the conversations is selected and further transmit the second storage request to the remote server; and the control module is further configured to generate a delete authorization in response to the first delete request and the second delete request, and further transmit the delete authorization to both the first intelligent terminal and the second intelligent terminal; and the first manage module is further configured to control the first storage unit to delete the conversations according to the delete authorization; and the second manage module is further configured to control the second storage unit to delete the conversations according to the delete authorization.

5. The interactive control system of claim 1, the first intelligent terminal comprising a first input unit, and the plurality of modules further comprising:
a first instruction module configured to generate a first instruction in response to a first user's operation applied on the first input unit and further transmit the first instruction to the remote server wherein the inquiry signal is generated in response to the first instruction.

6. The interactive control system of claim 1, the second intelligent terminal comprising a second input unit, the plurality of modules further comprising:
a second instruction module configured to generate a second instruction in response to a second user's operation applied on the second input unit and further transmit the second instruction to the remote server, wherein the inquiry signal is generated in response to the second instruction.

7. The interactive control system of claim 1, wherein the control module is further configured to generate an encryption key in response to both the first storage request and the second storage request, and further transmit the encryption key to both the first intelligent terminal and the second intelligent terminal; the conversations is further encrypted with the encryption key before storing by the first manage module and the second manage module, and the encryption key is further deleted by the first manage module and the second manage module.

8. The interactive control system of claim 7, wherein each time before opening the stored conversations, the first manage module or the second manage module are configured to obtain the encryption key from the remote server again and further decrypt the encrypted conversations according to the encryption key, and further delete the encryption key.

9. The interactive control system of claim 7, wherein after the conversations have been stored, the control module is further configured to control a third storage unit of the remote server to delete the encryption key when the conversations are selected to delete.

10. An interactive control method, applied to an intelligent terminal, the intelligent terminal comprising a storage unit, the control method comprising:
the intelligent terminal receiving an inquiry signal transmitted from a remote server;
the intelligent terminal inquiring a user whether to store conversations in response to the inquiry signal;
the intelligent terminal generating a first storage request when storing the conversations is selected and further transmitting the first storage request to the remote server, and further receiving a storage authorization transmitted from the remote server, wherein the storage authorization is generated by the remote server according to the first storage request and a second storage request generated by another intelligent terminal; and
the intelligent terminal controlling the storage unit to store the conversations according to the storage authorization.

11. The interactive control method of claim 10, the interactive control method further comprising:
the intelligent terminal generating a first delete request when deleting the conversations is selected and further transmitting the first delete request to the remote server and further receiving a delete authorization transmitted from the remote server, wherein the delete authorization is generated by the remote server according to the first delete request and a second storage request generated by the another intelligent terminal; and
the intelligent terminal controlling the storage unit to delete the conversations according to the delete authorization.

12. The interactive control method of claim 10, wherein the interactive control method further comprises:
the intelligent terminal receiving a delete authorization transmitted from the remote server, wherein the delete authorization is generated by the remote server according to the first storage request and a second delete request generated by the another intelligent terminal; and
the intelligent terminal controlling the storage unit to delete the conversations according to the delete authorization.

13. The interactive control method of claim 10, the interactive control method further comprising:
the intelligent terminal generating a first delete request when deleting the conversations is selected and further transmitting the first delete request to the remote server and further receiving a delete authorization transmitted from the remote server, wherein the delete authorization is generated by the remote server according to the first delete request and a second delete request generated by the another intelligent terminal; wherein the interactive control method further comprises:
the intelligent terminal controlling the storage unit to delete the conversations according to the delete authorization.

14. The interactive control method of claim 10, the intelligent terminal comprising an input unit, the interactive control method further comprising:
generating an instruction in response to a user's operation applied on the input unit and further transmitting the instruction to the remote server, wherein the inquiry signal is generated by the remote server in response to the instruction.

15. An intelligent terminal comprising:
a storage unit;
a processing unit; and
a plurality of modules which are collections of instructions executed by the processing unit, the plurality of modules comprising:
a select module configured to control to inquire a user whether to store conversations in response to the inquiry signal and generate a first storage request when storing the conversations is selected and further transmit the first storage request to a remote server, and further receives a storage authorization transmitted from the remote server, wherein the storage authorization is generated by the remote server according to the first storage request and a second storage request generated by another intelligent terminal; and
a manage module configured to control the storage unit to store the conversations according to the storage authorization.

16. The intelligent terminal of claim 15, wherein the select module is configured to generate a first delete request when deleting the conversations is selected, and transmit the first delete request to the remote server, and further receive a delete authorization transmitted from the remote server, wherein the delete authorization is generated according to the first select request and a second storage request generated by the another intelligent terminal by the remote server; and the manage module is further configured to control the storage unit to delete the conversations according to the delete authorization.

17. The intelligent terminal of claim 15, wherein the intelligent terminal further receives a delete authorization transmitted from the remote server, wherein the delete authorization is generated by the remote server according to the first storage request and a second delete request generated by another intelligent terminal, and the manage module is further configured to control the storage unit to delete the conversations according to the delete authorization.

18. The intelligent terminal of claim 15, wherein the select module is configured to generate a first delete request when deleting the conversations is deleted, and further transmit the first delete request to the remote server and further receives a delete authorization transmitted from the remote server, wherein the delete authorization is generated by the remote server according to the first delete request and a second delete request generated by another intelligent terminal, and the manage module is further configured to control the storage unit to delete the conversations according to the delete authorization.

19. The interactive control method of claim 15, the intelligent terminal comprising an input unit, the plurality of modules further comprising:
an instruction module configured to generate an instruction in response to a user's operation applied on the input unit and further transmit the instruction to the remote server, wherein the inquiry signal is generated by the remote server in response to the instruction.

20. The interactive control system of claim 15, wherein the conversations is further encrypted with an encryption key transmitted from the remote server before storing the conversations by the manage module, and the encryption key is further deleted by the manage module.
